(19) United States
(12) Patent Application Publication
(10) Pub. No.: US 2026/0243090 A1
(43) Pub. Date: Aug. 20, 2026

(54) INSULATION STRUCTURE FOR A FLOATING FLOOR HEATING SYSTEM AND FIBROUS INSULATION BOARD

(71) Applicants: ROCKWOOL A/S, Hedehusene (DK); FICOTEC VEREDELUNGS GMBH, Regensburg (DE)

(72) Inventors: Conrad Alex SCHLÜTER, Regensburg (DE); Moritz Oliver SCHLÜTER, Regensburg (DE); Paul Matthias BECKER, GLadbeck (DE)

(21) Appl. No.: 19/472,289

(22) PCT Filed: Apr. 2, 2024
(86) PCT No.: PCT/EP2024/058845

§ 371 Date: Oct. 3, 2025

(30) Foreign Application Priority Data
Apr. 4, 2023 (EP) 23166564.7

(51) Int. Cl. E04F 15/18

(52) U.S. Cl. CPC E04F 15/186

(57) ABSTRACT

An insulation structure for a floating floor heating system comprising a fibrous insulation board on which major top surface fixing elements are arranged and a heating pipe being held in place on top of the fibrous insulation board by the fixing elements, whereby the insulation board is covered with a composite facing layer directed to the heating pipe, whereby the composite facing layer is adhesively connected to a major top surface of the fibrous insulation board and whereby the composite facing layer is characterized in that it comprises a glass fibre tissue or fleece and a reinforcing element.

The invention relates to an insulation structure for a floating floor heating system comprising a fibrous insulation board on which major top surface fixing elements are arranged and a heating pipe being held in place on top of the fibrous insulation board by the fixing elements, whereby the insulation board is covered with a composite facing layer directed to the heating pipe, whereby the composite facing layer is adhesively connected to a major top surface of the fibrous insulation board. Furthermore, the invention relates to a fibrous insulation board for such an insulation structure, having a major top surface directed to a heating pipe of the insulation structure and covered with a composite facing layer.

Insulation structures for a floating floor heating system are known from the prior art and may comprise a faced insulation board, in particular a mineral wool insulation board. The faced insulation board serves as a thermal and acoustic insulation layer and at the same time as a substrate for a fixation of heating pipes with respective clamps or staples.

EP 3 495 743 A1 discloses an insulation structure with an insulation element as carrier for the heating pipes. The insulation element is made from a non-combustible thermal and acoustic insulation material and carries an upper layer. The upper layer being an impregnated web of filament material is connected to the insulation element by sewing a thread through both components.

DE 20 2015 100 914 U1 discloses a comparable system with an insulation mat having a first insulation layer made from fibres and a connecting layer for the fixation of the heating pipes. The connecting layer is flexible and made from a material different to the material of the first insulation layer to which the connecting layer is fixed by sewing, braiding, twisting or crimping.

The before described prior art has at least a drawback in production of the insulation mat according to DE 20 2015 100 914 U1 or of the system according to EP 3 495 743 A1. Both systems require a mechanical method step to connect the layers to each other which can only be done after the layers have been produced and can be joined together. To combine two layers and use a sewing method to connect the layers can have the disadvantage that it is necessary to interrupt a continuous production process and to finish the production in a discontinuous process step.

Furthermore, connecting two layers by a thread or the like may have the disadvantage that in case of a worker stepping on the insulation board may loosen the thread which can be destroyed in a next step of the worker walking on the insulation board and getting into contact with a shoe of the worker.

Furthermore, EP 0 607 616 A1 discloses an insulation board to be especially used in floors with a floor heating system. This insulation board comprises a first layer made of polystyrene foam and a second layer being impermeable for moisture and being made from a polystyrene foil. The second layer is glued to the first layer by using an adhesive based on polystyrene. Insulation boards made of foam have several drawbacks, especially shrinking problems over the years of use and these boards are less fire resistant.

It is an object of the invention to provide an insulation structure for a floating floor heating system and/or a fibrous insulation board for such an insulation structure having increased mechanical characteristics, such as increased stability and carrying capacity as well as fastening strength, i.e. pull-out strength for the fixing elements. Moreover, it is an object of the present invention to provide an insulation structure and/or a fibrous insulation board for such structure which is easy to produce in a continuous production process and providing an increased connection between layers.

To solve this object, the composite facing layer comprises a glass fibre tissue or a glass fibre fleece and a reinforcing element, which composite facing layer is adhesively connected to a major top surface of the fibrous insulation board and providing excellent pull-out strength for the fixing elements.

The invention is therefore related to an improved insulation structure for floating floor heating systems and fibrous insulation boards used in such a structure. The insulation structure comprises a faced insulation board serving as a thermal and acoustic insulation layer and at the same time as a substrate for the fixation of the heating pipes with respective clamps or staples. Said fibrous insulation board is covered with a facing layer being adhesively connected to a major surface of the insulation board and being formed as a combination of a glass fibre tissue or a glass fibre fleece, preferably a non-woven, and a reinforcing element, preferably a glass fibre mesh or a glass fibre grid. The advantage of such a facing layer in combination with an adhesive connection to the fibrous insulation board is that both layers can be connected in front of a curing oven without any additional means or treatment. Hence, the production results in a cheaper and more cost-competitive way compared to commercially available solutions requiring specialized fixation of foils or other facing layers using expensive stitching or sewing and having several drawbacks with respect to the mechanical characteristics of the insulation structure and/or the insulation board.

The composite facing layer can easily be applied and has an improved pull-out strength for the clamps and/or staples which can be easily applied to the insulation structure through the composite facing layer.

The before described advantages apply to the insulation structure and to the fibrous insulation board for the structure. In the following preferred embodiments of the structure and the fibrous insulation board are described. Fibrous insulation boards in the sense of the present disclosure are meant to cover e. g. mineral wool products according to or equivalent with European Standard EN 13162:2012+A1:2015, “Thermal insulation products for buildings—Factory made mineral wool (MW) products”. Hereinafter also referred to as mineral fibre, stone or glass fibre insulation boards or products. However, it is also thought to cover other fibrous insulation products, like e. g. factory made wood wool products (WW) according to EN 13168:2012+A1:2015 and others.

According to a first embodiment of the insulation structure and/or the fibrous insulation board the reinforcing element is made of a glass fibre mesh or a glass fibre grid having a plurality of cords being arranged parallel to each other and in two main directions, the two directions preferably being perpendicular to each other. Deviations from the preferred directions are optional. Because of the cords running perpendicular to each other the tensile strength is increased in both directions of the reinforcing element and a pattern being arranged by the cords over the whole surface of the insulation elements allows the installation of the clamps and/or staples without the risk to weaken the reinforcing element. The clamps and/or staples can easily be anchored with protruding barbes underneath the reinforcing element providing the possibility of securing the clamps and/or staples in a safe way inside the structure.

To strengthen the before-described advantages the cords arranged in at least one main direction are provided in equal distances to each other. Preferably the cords are arranged in both main directions accordingly, whereby the distances are preferably equal to each other in both directions and according to a further feature of the invention the cords running parallel to each other are arranged in a distance between 0.3 cm and 1 cm, preferably between 0.3 cm and 0.6 cm.

In case of equal distances between the cords in two directions the insulation boards can be used without any preferred orientation and in each case provide an easy and save placement of the clamps and/or staples. The preferred size of the distances between the cords allows for a safe fixation of the clamps and/or staples as known in the prior art (e. g. FIG. 2 of DE 20 2015 100 914U1 ).

To connect the composite facing layer adhesively to the fibrous insulation board by a heat curable binder, preferably the binder being used as binder in the fibrous insulation board is also used for adhering the facing layer. This way allows to apply the composite facing layer to the fibrous insulation board before a curing oven in which the binder in the fibrous insulation board is hardened in the same producing step as the adhesive between the composite facing layer and the fibrous insulation board. This feature decreases the costs of manufacture the fibrous insulation board.

According to a further preferred feature of the invention the composite facing layer is a mineral coated facing layer comprising the glass fibre tissue or the glass fibre fleece, the reinforcing element and the mineral coating. The composite facing layer is prefabricated and can be applied to the fibrous insulation board in one step and no hardening time for the composite facing layer on top of the fibrous insulation board is needed.

Preferably, the glass fibre fleece is a non-woven being easy to apply a cheap element to the composite facing layer and providing adequate mechanical characteristics.

According to a further preferred embodiment of the invention the combination of the fibrous insulation board and the composite facing layer has a peel-off resistance in the range of 1.5 to 7.0N/50 mm, preferably between 2.5 to 5.0 N/50 mm. Such peel-off resistance provides for a safe attachment of the clamps and/or staples within the insulation board even in cases where the clamps and/or staples or even an already installed heating pipe is exposed to a force parallel to the major surface of the insulation board, e. g. by unintended hitting of the heating pipe or the clamp and/or the staples by a foot of a worker walking across the insulation board. Preferably with respect to such an event it is a further preferred feature of the invention that the combination of the fibrous insulation board and the composite facing layer has a pull-out strength for the fixing elements in the range of 30 to 130 N, preferably between 40 to 80 N.

As a measure for a strong bond between layers, here the fibrous insulation board and the composite facing layer, and to ensure sufficient bonding the peel-off resistance or strength is a crucial feature to be elaborated while producing respective insulation elements. The peel-off resistance is an important measure for the strength of the connection between an insulation element and a second layer, e.g. a facing layer such as a glass-fleece. With other words, the adhesion of a respective glass-fleece on a fibrous insulation board is important. The peel-off resistance is tested by an internal method and shows the peeling strength which a product receives when it is bonded to e. g. a facing layer or lining element.

While testing the peeling strength, the second layer as a top layer is removed from the insulation element. The cross-sectional area of an adhesive connection is chosen to one third of the sample area. The peeling strength is measured perpendicular to the surface of the insulation element being bonded in its length with a facing layer.

First the test specimen is positioned or fixed in a guide rail, so that the facing layer can be peeled off vertically. I.e., the insulation element is vertically kept in place by the mentioned guide rail which is positioned at a lower traverse of a material testing machine, e.g. commercially available at ZwickRoell. Said guide rail however ensuring that the specimen can move in a horizontal direction and no additional shear forces are introduced while testing. One end of a respective facing layer is clamped into a mounting fixture at an upper traverse and comprising a load cell. The peeling strength for a given length is determined. The dimensions of the specimens are chosen to a length of 450 mm and a width of 150 mm for the insulation element. Said specimen respectively the facing layer is cut in a length direction so that a strip of 50 mm is formed in the middle of the sample. Over a length of 100 mm from the edge the facing layer is detached from the insulation element. This strip is clamped into the testing machine as already described above.

A pre-load of 2.5+/−0.25 N is applied and the facing layer is torn from the insulation element with a test speed of 100+/−5 mm/min, thereby giving a peeling strength measured in [N/50 mm]. Preferably the thermal and/or acoustic insulation element for use within an insulation structure for a floating floor heating system provides a peel-off resistance for the composite facing layer perpendicular to the major surface of the insulation element in the range of 1.5 to 7.0 N/50 mm, preferably between 2.5 to 5.0 N/50 mm.

Besides a strong bond between the layers, in order to ensure a safe fixation of the clamps and/or staples respectively the heating pipe on top of the fibrous insulation board, the pull-out strength for said fixing elements is an important feature. The pull-out strength is also tested according to an internal test method which will be described in more detail here below.

The pull-out strength (Fₘₐₓ) is defined as the maximum force required to pull a mounted heating pipe fixing element, such as a clamp or staple, out of the floor heating insulation product, i.e. the fibrous insulation board comprising the composite facing layer. Its dimension is [N].

Floor heating insulation products (including the facing layer, as described above) are cut into 300×300 mm samples. One fixing element is mounted in the centre, i.e. 150 mm from each edge of the sample. Typically, six samples are used for a measurement.

A commercially available universal tension testing machine, like e.g. the Bent Tram UTC machine comprising a respective test frame, a load cell and pull-out test program might be utilized for the measurements.

Prior to testing typically the dimensions, thickness and weight of the samples are measured and entered into the test program. A sample is horizontally installed in the appropriate test frame keeping the sample in place and the Bent Tram test sequence for the pull-out test applied.

A pre-load of 20 N is applied, subsequently measurement takes place with a speed of 10 mm/min. until breakage of the sample, i.e. until the fixing element basically is pulled out of the sample respectively a load peak has crossed. Data in the form of load, deformation and time is collected and illustrated in a graphical representation.

The pull-out strength (Fₘₐₓ) equals the measured force at the load peek respectively the documented maximum force required to pull out the fixing element. Fibrous insulation boards comprising the composite facing layer for use with an insulation structure for a floating floor heating system according to the present invention achieve a pull-out strength for the fixing elements in the range of 30 to 130 N, preferably between 40 to 80 N.

Preferably, the combination of the fibrous insulation board and the composite facing layer fulfils “Fireclass A” according to European Standard EN 13501-1:2018, so that the combination of the fibrous insulation board and the composite facing layer can be used in areas where increased requirements with respect to fire prevention are given.

In accordance with higher or increased requirements with respect to fire prevention it has been found that the amount of binder between the fibrous insulation board and the composite facing layer is limited to between 50 g/m² and 100 g/m² after curing (dry weight). The insulation structure having an amount of binder in this range represents no additional fire load which would constitute further provisions in the building structure to prevent a fire spread.

With respect of an increased stability of the fibrous insulation board, the board preferably has a bulk density between 90 kg/m³ and 160 kg/m³ allowing to walk on the insulation structure while assembling the heating pipe on the fibrous insulation board being covered with the composite facing layer. Furthermore, the composite facing layer including the coating has a surface weight between 250 g/m² and 600g/m² , preferably between 350 g/m² and 500g/m² .

A preferred embodiment of the fibrous insulation board has a composite facing layer covering the major surface of the fibrous insulation board full-face. Additionally, the fibrous insulation board has a first edge and the composite facing layer protrudes the first edge preferably over the total length of the first edge. The protruding part of the composite facing layer can be used to be arranged on a part of a fibrous insulation board being arranged adjacently and which closes a possible gap between two abutting faces of the fibrous insulation arranged adjacently. Thereby preventing access of humidity, e. g. from floor screed to be placed on top of the insulation structure, into the area between several fibrous insulation boards. Such humidity could harm the building structure and the thermal performance of the fibrous insulation boards and in case of floor screed would significantly reduce the acoustic properties of the insulation structure.

As an alternative or additionally it is, according to another preferred embodiment of the invention, provided that at least two fibrous insulation boards are provided side by side and a joint between the fibrous insulation boards is covered by an adhesive tape fixed to both fibrous insulation boards. The tape can close the joint or can be used to fix the protruding part of the composite facing layer to the composite facing layer of a fibrous insulation board so as to close the joint indirectly and preventing the ingress of water between two fibrous insulation boards being arranged adjacently to each other.

Preferably, the fibrous insulation board is a mineral fibre insulation board, especially a stone or glass fibre insulation board.

With respect to the composite facing layer there is an interest in driving fastening clamps and/or staples into a fibrous insulation board for fixing a heating pipe, especially a hose for underfloor heating. The aim of the clamps and/or staples is to securely fix the heating pipe or hose to the insulation structure. For example, the clamps and/or staples should hold the pipe or hose laid on the fibrous insulation board in position against the restoring force of uncoiled hoses or tripping during laying. While the non-combustibility of the fibrous insulation board is to be maintained, at the same time the composite facing layer must meet the pull-out resistance for the fixing elements, i.e. the clamps and/or staples.

For this purpose, a glass fibre tissue or fleece is adhesively connected to a glass fibre mesh or grid. In principle, a glass fiber scrim can also be used. The connection of such facing layer on the fibrous insulation board would not be sufficient to have a sufficient pull-out and peel-off resistance. For this purpose, the facing layer is additionally coated with a mineral non-combustible paste forming a composite facing. Here, the coating stabilizes the composite facing layer and helps to prevent damages to the fibrous insulation board during installation of the insulation structure. It also acts as an adhesion promoter for the bonding between the fibrous insulation board and the composite facing layer.

The composite facing layer is therefore a composition of essentially three individual components as will be apparent in more detail from below discussion.

First, a glass fibre mesh or grid is applied to a non-combustible glass fibre non-woven. For this purpose, a finished glass fibre non-woven with an appropriate nominal area weight and a fiber bonding e.g. based on melamine resin, urea resin, acrylate or PVC is provided. As a second component, an untreated glass fibre mesh or grid is impregnated with a non-combustible finish. While still wet, the two sheet-like structures are brought together, pressed and dried. The finish serves to bond the glass fibre mesh or grid to the glass fibre non-woven. The result is a solid intermediate composite of a glass fibre non-woven and a glass fibre mesh or grid which is usually wound into rolls.

In a subsequent process, this intermediate composite is unwound and a liquid, substantially mineral-based coating compound is applied to the intermediate composite, e. g. by means of a doctor blade. In this process, the intermediate composite is completely impregnated. The coating compound is a dispersion of flame-retardant particles (aluminum trihydrate, magnesium hydroxide or potential others), a binder and additives. During coating, care must be taken to ensure that the porosity of the coating, measured in air permeability, is within the specified limits. The wetted compound is passed through a dryer and dried. The result is a sheet-like structure with a nominal basis weight at a defined air permeability. In a subsequent process, the finished product, i.e. the final composite facing layer is transferred to the fibrous insulation board and fixed thereto as has been described above.

Further features, advantages and aspects of the invention are described in the following description of a preferred embodiment shown in the attached drawing. The drawing shows in

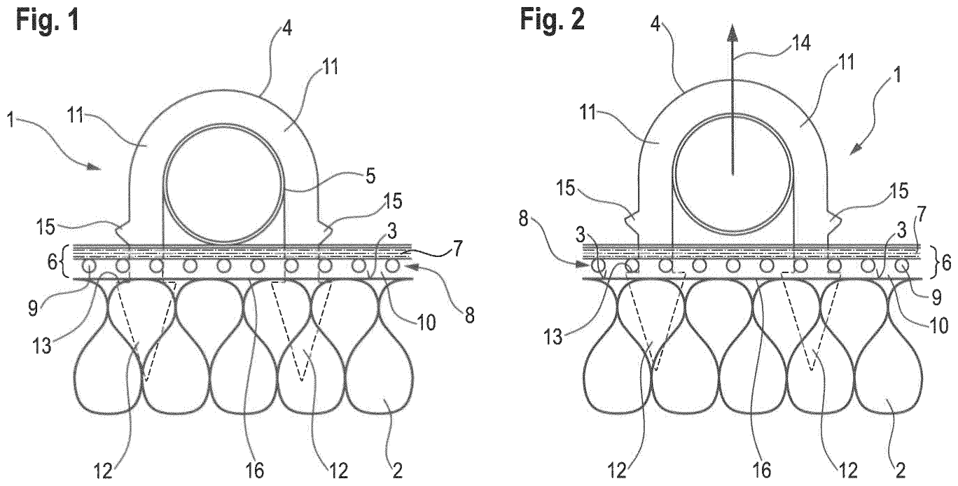

FIG. 1 a part of an insulation structure for a floating floor heating system in cross section;

FIG. 2 the system according to FIG. 1 with an applied force to a heating pipe and in

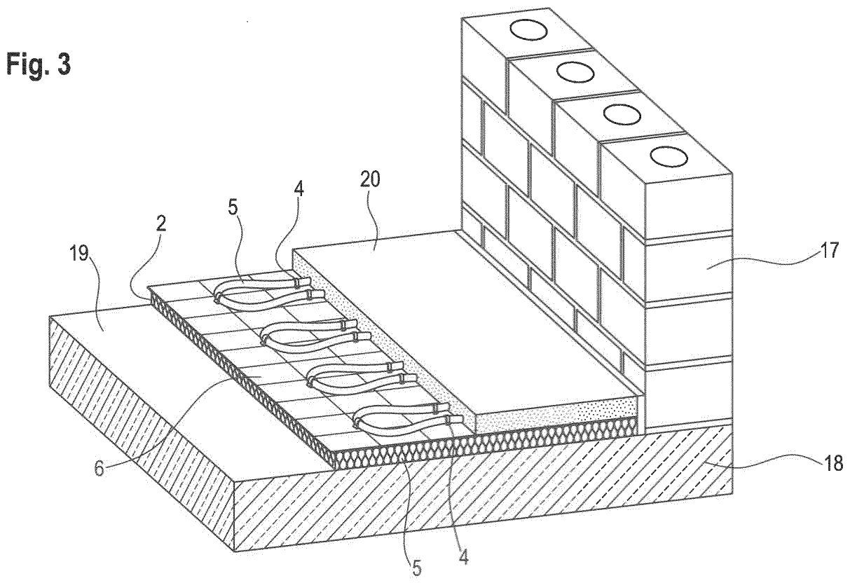

FIG. 3 a part of a building with a floating floor heating system in perspective view.

FIGS. 1 and 2 show a part of an insulation structure 1 for a floating floor heating system comprising a fibrous insulation board 2 on which major top surface 3 fixing elements 4 are arranged and a heating pipe 5 being held in place on top of the fibrous insulation board 2 by the fixing elements 4, whereby the insulation board 2 is covered with a composite facing layer 6 directed to the heating pipe 5, whereby the composite facing layer 6 is adhesively connected to the major top surface 3 of the fibrous insulation board 2.

The composite facing layer 6 comprises a glass fibre tissue 7 and a reinforcing element 8. The reinforcing element 8 is made of a glass fibre mesh having a plurality of cords 9 being arranged parallel to each other and in two main directions, the two directions being perpendicular to each other. The cords 9 arranged in both directions are provided in equal distances to each other which distance is 0.5 cm.

The composite facing layer 6 is adhesively connected to the fibrous insulation board 2 by a heat curable binder being used as binder in the fibrous insulation board 2. The amount of binder between the fibrous insulation board 2 and the composite facing layer 6 is about 75 g/m² after curing (dry weight). Furthermore, the composite facing layer 6 including the coating 10 has a surface weight of about 400 g/m².

The fibrous insulation board 2 is a mineral fibre insulation board, namely a stone fibre insulation board having a bulk density of 140 kg/m³.

The combination of the fibrous insulation board 2 and the composite facing layer 6 has a pull-out strength for the fixing elements 4 in the range of 80 N and a peel-off resistance in the range of 5.0N/50 mm.

Each fixing element 4 is generally U-shaped and has two legs 11 running parallel to each other. At each free end of the legs 11 a piercing element 12 is provided which has a triangular cross section allowing to penetrate through the composite facing layer 6 by using a small force. Each piercing element 12 has at the opposite end of its free end an increased cross section compared to the cross section of the leg 11 to which it is fixed. The increased cross section of the piercing element forms barbed hooks 13 anchoring the fixing element 4 inside the insulation structure 1 even in case a force in the direction of an arrow 14 is applied to the fixing element 4.

Finally, the legs 11 are equipped with at least one protrusion 15 erecting orthogonal to the legs 11 and being used to limit the part of the legs 11 being inside the fibrous insulation board 2 and running through composite facing layer 6. Therefore, in the intended position of the fixing element 4 in the insulation structure 1 the barbed hooks 13 are close to an upper surface 16 of the composite facing layer or even lay on the surface 16 of the composite facing layer 6.

FIG. 3 shows a part of a building represented by a wall 17 erecting on a floor 18. The floor has an upper floor surface 19 on which fibrous insulation boards 2 are placed. On the top surface 3 of the fibrous insulation boards the composite facing layer 6 is arranged.

The floor heating system shown in FIG. 3 comprises the heating pipe 5 being arranged slope-like on top of the composite facing layer 6 and being covered by and incorporated in a floor screed 20. The heating pipe 5 is fixed to the fibrous insulation boards 2 by several fixing elements 4 penetrating through the composite facing layer 6 into the fibrous insulation

### REFERENCE SIGNS

1 insulation structure
2 fibrous insulation board
3 top surface
4 fixing element
5 heating pipe
6 composite facing layer
7 glass fibre tissue
8 reinforcing element
9 cord
10 coating
11 leg
12 piercing element
13 barbed hook
14 arrow
15 protrusion
16 surface
17 wall
18 floor
19 upper floor surface
20 floor screed

1. An insulation structure for a floating floor heating system comprising a fibrous insulation board on which major top surface fixing elements are arranged and a heating pipe being held in place on top of the fibrous insulation board by the fixing elements, whereby the insulation board is covered with a composite facing layer directed to the heating pipe, whereby the composite facing layer is adhesively connected to a major top surface of the fibrous insulation board and whereby the composite facing layer comprises a glass fibre tissue or fleece and a reinforcing element.

2. The insulation structure according to claim 1,
wherein
the reinforcing element is made of a glass fibre mesh or a glass fibre grid having a plurality of cords being arranged parallel to each other and in two main directions, preferably the two directions being perpendicular to each other.

3. The insulation structure according to claim 2,
wherein
the cords arranged in at least one main direction are provided in equal distances to each other.

4. The insulation structure according to claim 2,
wherein
the cords running parallel to each other are arranged in a distance between 0.3 cm and 1 cm, preferably between 0.3 cm and 0.6 cm.

5. The insulation structure according to claim 1,
wherein
the composite facing layer is a mineral coated facing layer comprising the glass fibre tissue or the glass fibre fleece, the reinforcing element and the mineral coating.

6. The insulation structure according to claim 5,
wherein
the composite facing layer including the coating has a surface weight between 250 g/m² and 600g/m², preferably between 350 g/m² and 500g/m².

7. The insulation structure according to claim 1,
wherein
the combination of the fibrous insulation board and the composite facing layer has a peel-off resistance in the range of 1.5 to 7.0 N/ 50mm, preferably between 2.5 to 5.0 N/50mm.

8. The insulation structure according to claim 1,
wherein
the combination of the fibrous insulation board and the composite facing layer have a pull-out strength for the fixing elements in the range of 30 to 130 N, preferably between 40 to 80 N.

9. The insulation structure according to claim 1,
wherein
the fibrous insulation board has a first edge and that the composite facing layer protrudes the first edge preferably over the total length of the first edge.

10. The insulation structure according to claim 1,
wherein
at least two fibrous insulation boards are provided side by side and a joint between the fibrous insulation boards is covered by an adhesive tape fixed to both fibrous insulation boards.

11. The insulation structure according to claim 1,
wherein
the fibrous insulation board is a mineral fibre insulation board, especially a stone or glass fibre insulation board.

12. A fibrous insulation board for an insulation structure according to claim 1, having a major top surface directed to a heating pipe of the insulation structure and covered with a composite facing layer
wherein
the composite facing layer is adhesively connected to the major top surface of the fibrous insulation board and comprises a glass fibre tissue or fleece and a reinforcing element.

13. The fibrous insulation board according to claim 12,
wherein
the reinforcing element is made of a glass fibre mesh or a glass fibre grid having a plurality of cords being arranged parallel to each other and in two main directions, preferably the two main directions being perpendicular to each other.

14. The fibrous insulation board according to claim 13,
wherein
the cords arranged in at least one main direction are provided in equal distances to each other.

15. The fibrous insulation board according to claim 13,
wherein
the cords running parallel to each other are arranged in a distance between 0.3 cm and 1 cm, preferably between 0.3 cm and 0.6 cm.

16. The fibrous insulation board according to claim 12,
wherein
the composite facing layer is a mineral coated facing layer comprising the glass fibre tissue or the glass fibre fleece, the reinforcing element and the mineral coating.

17. The fibrous insulation board according to claim 16,
wherein
the composite facing layer including the coating has a surface weight between 250 g/m² and 600 g/m² , preferably between 350 g/m² and 500 g/m².

18. The fibrous insulation board according to-any claim 12,
having a peel-off resistance for the composite facing layer in the range of 1.5 to 7.0 N/ 50mm, preferably between 2.5 to 5.0 N/ 50mm.

19. The fibrous insulation board according to claim 12,
having a pull-out strength for the fixing elements in the range of 30 to 130 N, preferably between 40 to 80 N.

20. The fibrous insulation board according to claim 12,
having a first edge whereby the composite facing layer protrudes the first edge preferably over the total length of the first edge.

21. The fibrous insulation board according to claim 12,
being a mineral fibre insulation board, especially a stone or glass fibre insulation board.
